(19) United States
(12) Patent Application Publication
(10) Pub. No.: US 2018/0319381 A1
(43) Pub. Date: Nov. 8, 2018

(54) CONTROL SYSTEM AND METHOD FOR ANTI-LOCK BRAKING SYSTEM FOR AUTONOMOUS VEHICLE

(71) Applicant: Caterpillar Inc., Peoria, IL (US)

(72) Inventors: Andy Vitale, Edwards, IL (US); Joshua Struble, Chillicothe, IL (US); Ananth Kini, Dunlap, IL (US); Kevin Davis, Washington, IL (US)

(21) Appl. No.: 15/587,578

(22) Filed: May 5, 2017

(51) Int. Cl. B60T 8/1761; B60T 7/12; B60T 8/172; B60T 8/1755; B60T 8/72

(52) U.S. Cl. CPC B60T 8/1761; B60T 7/12; B60T 8/72; B60T 8/1755; B60T 8/172

(57) ABSTRACT

An anti-lock braking system for an autonomous vehicle includes a memory storing instructions relating to braking control, a detection system for detecting an event necessitating braking of the autonomous vehicle, and a controller. The controller is in communication with the detection system and is configured to execute the instructions to receive detection and identification of the event, determine a vehicle deceleration rate based on the identification of the event, and operate the anti-lock braking system in a selected mode of a plurality of different predetermined operating modes based on the vehicle deceleration rate.

### TECHNICAL FIELD

The present disclosure relates generally to an anti-lock braking system, and more particularly to a control system and method for automatically selecting an operating mode for an anti-lock braking system for an autonomous vehicle.

### BACKGROUND

Utilization of autonomous vehicles, or autonomous machines, is becoming more prevalent and offers particular advantages in the mining industry, for example. Specifically, autonomous vehicles may be operated in environments unsuitable for human operators, such as, for example, at high altitudes or in sparsely populated desert regions. In addition, autonomous vehicles may be operated for longer periods of time than manned machines, thus providing increased productivity, and may be operated according to strict control strategies aimed at optimizing efficiency and reducing emissions. Further, by optimizing operation, maintenance costs for the autonomous vehicle may potentially be reduced. Work sites, such as mines, utilizing autonomous vehicles may incorporate a fleet of autonomous machines with a variety of semi-autonomous and manned vehicles or machines. Thus, safety and reliable control of the autonomous vehicles is of vital importance.

U.S. Pat. No. 8,046,146 to Osborn et al. discloses an adaptive anti-lock braking system and method. A first anti-lock braking strategy is determined in response to a sensed wheel slip condition. The strategy includes monitoring a distance differential of at least one target in proximity to a driven vehicle. A second anti-lock braking strategy is determined based on the distance differential and by modifying the first anti-lock braking strategy.

As should be appreciated, there is a continuing need to improve operation of autonomous vehicles, including the braking systems thereof.

### SUMMARY OF THE INVENTION

In one aspect, an anti-lock braking system for an autonomous vehicle includes a memory storing instructions relating to braking control, a detection system for detecting an event necessitating braking of the autonomous vehicle, and a controller. The controller is in communication with the detection system and is configured to execute the instructions to receive detection and identification of the event, determine a vehicle deceleration rate based on the identification of the event, and operate the anti-lock braking system in a selected mode of a plurality of different predetermined operating modes based on the vehicle deceleration rate.

In another aspect, a method for identifying a selected mode for an anti-lock braking system of an autonomous vehicle is provided. The method includes steps of detecting an event necessitating braking of the autonomous vehicle using a detection system, and receiving detection and identification of the event at a controller. The controller determines a vehicle deceleration rate based on the identification of the event, and operates the anti-lock braking system in the selected mode of a plurality of different predetermined operating modes based on the vehicle deceleration rate.

In yet another aspect, a control system for an anti-lock braking system of an autonomous vehicle includes a memory storing instructions relative to braking control, and a controller. The controller is configured to execute the instructions to receive detection and identification of an event necessitating braking of the autonomous vehicle, determine a vehicle deceleration rate based on the identification of the event, and operate the anti-lock braking system in a selected mode of a plurality of different predetermined operating modes based on the vehicle deceleration rate.

### BRIEF DESCRIPTION OF THE DRAWINGS

FIG. 1 is a schematic view of an exemplary lane illustrating movement of an autonomous vehicle along an intended path, according to one aspect of the present disclosure;

FIG. 2 is another schematic view of the lane and autonomous vehicle of FIG. 1, according to another aspect of the present disclosure;

FIG. 3 is a block diagram of an exemplary control system for the autonomous vehicle, according to another aspect of the present disclosure; and

FIG. 4 is a flow chart representing exemplary primary steps of a control strategy described herein, according to another aspect of the present disclosure.

### DETAILED DESCRIPTION

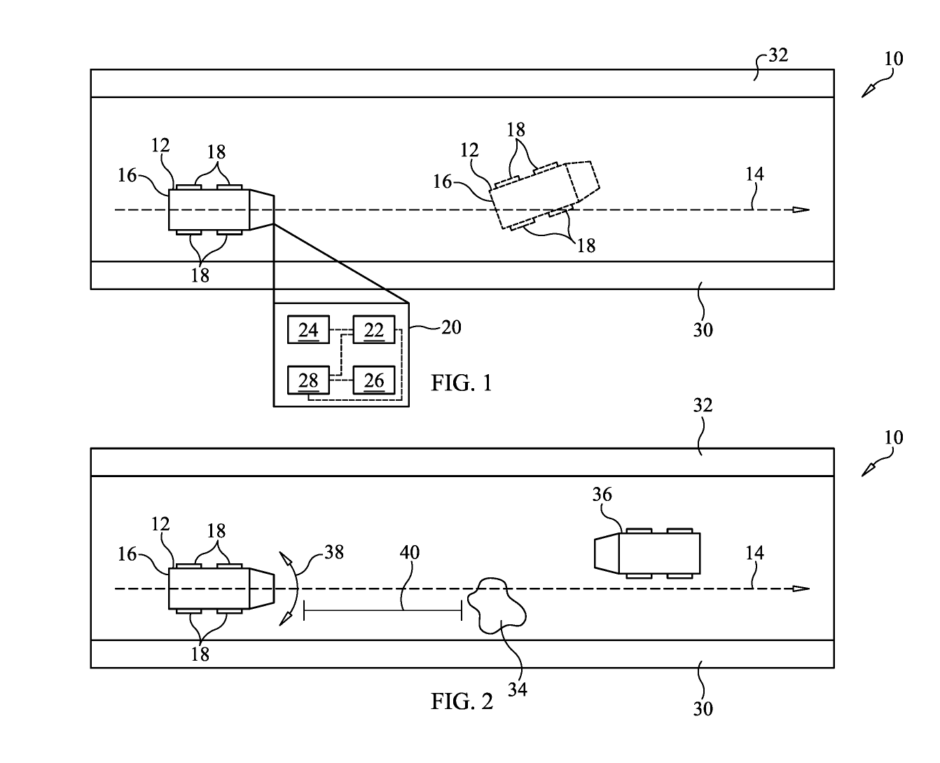

FIG. 1 depicts a segment of a lane 10 illustrating movement of an autonomous vehicle 12 along a planned path 14. The autonomous vehicle 12, according to an exemplary embodiment, may be used at a work site. According to a specific example, the work site may be a mine environment utilizing heavy equipment, such as haulage vehicles, excavators, backhoes, front-end loaders, mining shovels, etc., to excavate and transport materials from a mine site to a production facility. The autonomous vehicle 12 may be equipped for on-road and/or off-road travel and may include a chassis, or frame, 16 supporting a plurality of ground engaging elements, such as wheels, 18. Although the autonomous vehicle 12 is described as a mining truck, or haulage vehicle, it should be appreciated that the control strategy provided herein is broadly applicable to a variety of vehicles utilized at various work sites, or in other environments, that incorporate any combination of autonomous, semi-autonomous, and manned vehicles or machines.

The autonomous vehicle 12 may include a control system, also referred to as an electronic control system 20, supported on the chassis 16 and including a controller 22, such as a main controller, a positioning system 24, and a navigation system 26, or any number or combination of devices, including onboard and remote devices, providing the functionality described herein. The controller 22 is configured for drive-by-wire operation of the autonomous vehicle 12 and, thus, is in control communication with various components of the autonomous vehicle 12, including the positioning system 24 and the navigation system 26, to control at least the speed and direction of travel of the autonomous vehicle 12. As should be appreciated, the controller 22 may also be in communication with various sensors and other devices in order to monitor and, thus, effectively control the autonomous operation of the autonomous vehicle 12. Any number of controllers or control devices may be provided.

Generally, the navigation system 26 may receive, access, and/or store a route plan that is used to control operation of the autonomous vehicle 12. For example, a centralized or remote control system may generate and/or update the route plan and transmit the route plan information to the autonomous vehicle 12 over a wireless network. According to one example, the route plan may include a terrain map of the work site that includes positions of various materials, hazards, and equipment, including the autonomous vehicle 12, located at the work site. The route plan may also include the planned path 14, or intended travel path, associated with a specific task for the autonomous vehicle 12.

The navigation system 26 may be in communication with the positioning system 24, which may include one or more global positioning system (GPS) units receiving information from satellites to calculate machine position information, which may include at least a position and an orientation of the autonomous vehicle 12. The navigation system 26 may use the machine position information to establish a current location of the autonomous vehicle 12 and then determine how the autonomous vehicle 12 must be controlled, such as by controlling propulsion, steering, braking, and the like, to move the autonomous vehicle 12 along the planned path 14.

The controller 22, the navigation system 26, and the positioning system 24 may include a processor, such as, for example, a central processing unit, a memory, and an input/output circuit that facilitates communication internal and external to the respective electronic device. Each respective processor may control operation of the respective controller 22, navigation system 26, or positioning system 24 by executing operating instructions, such as, for example, computer readable program code stored in memory, wherein operations may be initiated internally or externally to the respective controller 22, navigation system 26, or positioning system 24. A control scheme may be utilized that monitors outputs of systems or devices, such as, for example, sensors, actuators, or control units, via the input/output circuit to control inputs to various other systems or devices.

The memory may comprise temporary storage areas, such as, for example, cache, virtual memory, or random access memory, or permanent storage areas, such as, for example, read-only memory, removable drives, network/internet storage, hard drives, flash memory, memory sticks, or any other known volatile or non-volatile data storage devices. Such devices may be located internally or externally to the respective controller 22, navigation system 26, or positioning system 24. One skilled in the art will appreciate that any computer based system or device utilizing similar structures for controlling the components of the autonomous vehicle 12 is suitable for use with the present disclosure.

The autonomous vehicle 12 and/or, more particularly, the control system 20 may also include a detection system 28, which may also function as an obstacle avoidance system, for effectively controlling the autonomous vehicle 12. For example, the detection system 28 may communicate with or include obstacle detection and avoidance devices or features, which may incorporate laser, vision, and radar sensors, to name a few. According to an exemplary embodiment, the detection system 28 may communicate with or include a light detection and ranging system (LIDAR) and/or other components and devices used in known ways to detect and avoid obstacles and maneuver the autonomous vehicle 12 according to instructions provided in the route plan. The autonomous vehicle 12 may also be equipped with inertial measurement devices, which indicate to the control system 20 how the autonomous vehicle 12 is moving. According to the present disclosure, the detection system 28 may be configured to detect events necessitating braking of the autonomous vehicle 12.

Using any or all of the navigation system 26, the positioning system 24, and the detection system 28, the control system 20 may be programmed and/or configured to predict, or project, movement of the autonomous vehicle 12 along the planned path 14. If it is determined that the autonomous vehicle 12 has already deviated, is currently deviating, and/or will deviate from the planned path 14, based on current or projected vehicle movement, the control system 20 may identify the deviation, store or transmit information regarding the deviation, and/or initiate some action in response to the deviation.

For example, the control strategy provided herein may include means for selecting or modifying a desired travel speed for the autonomous vehicle 12 and/or initiating or controlling deceleration of the autonomous vehicle 12 based on the deviation. A phantom autonomous vehicle 12 in FIG. 1 illustrates a potential deviation. A deviation may also be identified if the autonomous vehicle 12 enters or crosses lane boundaries 30, 32, or deviates from the planned path 14 at least a predetermined distance or amount.

Further, the control system 20 or, more particularly, the detection system 28, may use LIDAR, for example, to detect objects or obstacles within a predetermined proximity to the autonomous vehicle 12, and/or detect another vehicle within a predetermined proximity to the autonomous vehicle 12. Referring to FIG. 2, for example, the detection system 28 may use any of a variety of known detection devices to detect or sense an object 34 within a predetermined proximity to the autonomous vehicle 12 and/or may detect another vehicle 36 within a predetermined proximity to the autonomous vehicle 12. As indicated above, the detection system 28 may be configured to cause the autonomous vehicle 12 to decelerate or stop responsive to detection of the object 34 and/or the other vehicle 36, which may be located along the planned path 14 of the autonomous vehicle 12 or positioned such that the autonomous vehicle 12 may not proceed in a desirable manner.

Additional and/or alternative events may also be detected and identified by the control system 20, including, for example, a failure condition of a component or system of the autonomous vehicle 12. For example, a sensor, or other device of the autonomous vehicle 12 may be monitored such that a problem or failure is electronically detected. The control system 20 may receive an indication of the problem or failure and, if deemed appropriate, the control strategy herein may be applied. That is, if warranted, the sensor problem or failure may cause the autonomous vehicle 12 to decelerate or stop, as described herein.

The above referenced events, and others, may be characterized as events necessitating braking of the autonomous vehicle 12. That is, the deviation from the planned path 14 and detection of the object 34 or other vehicle 36 within close proximity to the autonomous vehicle 12 may be considered events necessitating braking of the autonomous vehicle 12 to avoid undesirable operation of the autonomous vehicle 12, for purposes of the present disclosure. Various other events, including, for example, road conditions, weather, break pad age, and route information, may necessitate braking or stopping of the autonomous vehicle 12, and may be incorporated into the strategy provided herein. The specific events described herein are provided for exemplary purposes only, and may only be suitable for particular applications.

As mentioned above, the control strategy taught herein includes the detection and identification of such an event, the identification of a deceleration rate for the autonomous vehicle 12 that corresponds to the event, and the automatic selection of a particular operating mode of a plurality of different predetermined operating modes for decelerating and stopping the autonomous vehicle 12, with the particular operating mode being automatically selected based on the deceleration rate. That is, when an event is detected, using monitoring, sensing, and the like, the event is properly identified such that the event may be appropriately mapped to a deceleration rate.

The various operating modes may differ in various ways, including, for example, placing emphasis on different performance, or braking, characteristics. One exemplary performance characteristic is yaw control, which is illustrated by arrow 38, and another performance characteristic is stopping distance 40. Various other performance characteristics may be prioritized in various operating modes and/or the level or degree to which the performance characteristics are prioritized may vary. That is, there may be various operating modes corresponding to different levels or degrees of yaw control.

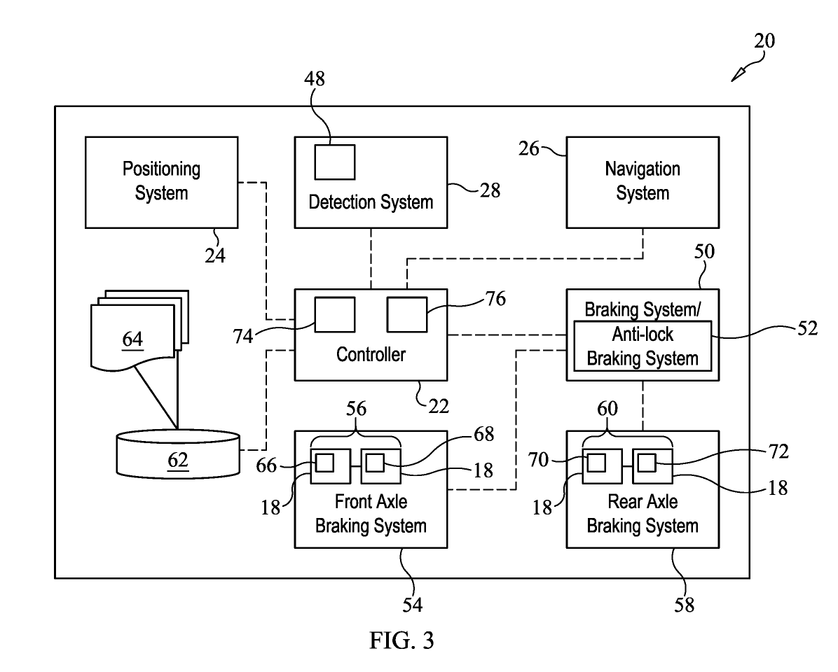

Turning now to FIG. 3, the exemplary control system 20 for the autonomous vehicle 12, according to the present disclosure, may include the systems and/or components discussed above, including the controller 22, navigation system 26, positioning system 24, and detection system 28, which may include LIDAR 48 or other detection or sensing means. It should be appreciated that the control system 20, as described herein, uses “system” for each of the navigation system 26, positioning system 24, and detection system 28 for ease of explanation rather than limitation. That is, each “system” is called out and discussed separately to more clearly describe the various functions performed by the control system 20 of the autonomous vehicle 12.

The control system 20 may also include or communicate with, among other machine systems, a braking system 50, which may be any of a variety of known braking systems, including friction brakes, and the like. The braking system 50 may include an anti-lock braking system 52, the standard functionality of which is known in the art. The braking system 50, and anti-lock braking system 52, may be configured and connected to control, decelerate, or brake, a front axle braking system 54, which may include a front set 56 of ground-engaging elements 18, and a rear axle braking system 58, which may include a rear set 60 of ground-engaging elements 18.

According to some embodiments, both ground-engaging elements 18 of the front set 56 may be controlled together, while both ground-engaging elements 18 of the rear set may be controlled together. The anti-lock braking system 52 may also include or communicate with at least one sensor 66, 68, 70, and 72 positioned at each of the ground-engaging elements 18 to identify potential slippage at a particular one of the ground engaging elements 18. As a result, the detection of wheel slippage may be used to determine which of the front axle braking system 54 and the rear axle braking system 58, or the axles thereof, may be controlled using the control strategy provided herein.

Components or devices of the control system 20 may also include a data storage device 62, which may include memory, or a database, or other storage means, for storing instructions relating to braking control, such as a braking control program, 64, which may include computer readable program code. The controller 22, which may include a processor 74 and memory 76 as described above, and may be in communication with the various components and devices of the control system 20 via communication lines 78, may be configured or programmed to execute the braking control program 64 for deceleration and/or stopping or braking the autonomous vehicle 12 according to the control strategy of the present disclosure. Additional and/or alternative systems, devices, and components may be incorporated for executing the control strategy described herein, and such systems, devices, and components may be local and/or remote.

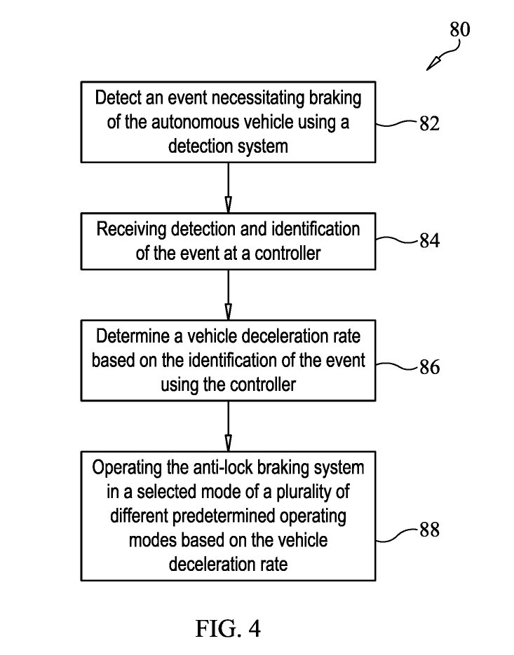

With specific reference to FIG. 4, there is shown a flow chart 80 representing primary steps of an exemplary method for controlling the autonomous machine 12 according to the control strategy or, more particularly, braking strategy provided here. The method, which may be implemented by executing the braking control program 64, may be in the form of computer readable program code stored in the memory 76 and executed by the processor 74 of the controller 22. The method may run continuously or may be initiated in response to a predetermined event, such as, for example, the detection and identification of an event necessitating braking, as described above.

For example, the method may begin at box 82, which may include the detection of an event necessitating braking of the autonomous vehicle 12 using the detection system 28. That is, the detection system 28 may detect and identify events such as a deviation from the planned path 14, an object 34 within a predetermined proximity to the autonomous vehicle 12, or another vehicle 36 within a predetermined proximity to the autonomous vehicle 12. Various other events, including, for example, road conditions, weather, break pad age, and route may also be detected and identified by the control system 20. At a next step, at box 84, the controller 22 may receive the detection and/or the identification of the event. The detection system 28, or other system or device of the control system 20, may perform additional tasks, such as, for example, determining the location of the object 34 or vehicle 36, and the distance between the object 34 or vehicle 36 and the autonomous vehicle 12.

The controller 22 may then determine a vehicle deceleration rate for the autonomous vehicle 12 based on the identification of the event, at box 86. For example, various events may be associated with or mapped to different vehicle deceleration rates. That is, a table may exist in a memory or other storage devices, including events that may be detected and deceleration rates associated with the events. For events corresponding to the detection of the object 34 or the other vehicle 36, distances may be mapped to different obstacles or obstructions. Thus, the vehicle deceleration rate may be based on the event itself and the distance between the obstacle or obstruction and the autonomous vehicle 12. The association of deceleration rates to events may also be based on an identified stopping point, which may correspond to the distance between the obstacle or obstruction and the autonomous vehicle and a current speed of the autonomous vehicle 12. In some embodiments, the controller 22 may calculate a deceleration rate based on the event, the stopping point, and/or the current speed.

An operating mode, of a plurality of different predetermined operating modes, for the anti-lock braking system 52 may be selected, by the controller 22, based on the vehicle deceleration rate. At box 88, the anti-lock braking system 52 may be operated in the selected operating mode. For example, the controller 22 may be configured to operate the anti-lock braking system 52 in a “short stopping distance mode” if the vehicle deceleration rate is above a predetermined threshold or within a particular range. For example, the predetermined threshold may be any selected value, including corresponding to a maximum deceleration rate. Alternatively, the controller 22 may be configured to operate the anti-lock braking system 52 in a “yaw control mode” if the vehicle deceleration rate is below a predetermined threshold. The “short stopping distance mode” may prioritize stopping distance over yaw control, or other stability control, while the “yaw control mode” may prioritize yaw control, or other stability control, over stopping distance.

The controller 22 may also be in communication with the sensors 66, 68, 70, and 72 positioned at each of the ground-engaging elements 18 to identify potential slippage at a particular one of the ground engaging elements 18. According to one exemplary control strategy, the controller 22 may be configured to operate the anti-lock braking system 52 in the selected mode, based on the identified event and the vehicle deceleration rate, to control the axle supporting the particular ground-engaging element 18 exhibiting potential slippage.

That is, for example, in “yaw control mode,” the controller 22 may control brake limiting around the ground-engaging element 18, of pair 56 or 60, that has the most slip. This mode may help with controlling yaw, but may also have the side effect of limiting braking to the ground-engaging element 18 of pair 56 or 60 that still has traction. For “shortest stopping distance mode,” the controller 22 may control brake limiting around the ground-engaging element 18, of pair 56 or 60, that has the least slip. In some cases, if one ground-engaging element 18 in the pair 56 or 60 still has traction, the anti-lock braking system 52 will not be activated for that pair 56 or 60. It may not be until both ground-engaging elements 18 in the pair 56 or 60 have lost some amount of traction before the braking force is limited using the anti-lock braking system 52.

### INDUSTRIAL APPLICABILITY

The present disclosure finds potential application in any vehicle or machine braking system. Further, the present disclosure may be applicable to braking systems for autonomous or semi-autonomous vehicles operating at a work site. Yet further, the present disclosure may be particularly applicable to a control system and method for automatically selecting an operating mode for an anti-lock braking system for an autonomous or semi-autonomous vehicle.

Referring generally to FIGS. 1-4, an exemplary autonomous vehicle 12 may include a chassis, or frame, 16 supporting a plurality of ground-engaging elements 18. The autonomous vehicle 12 may include a control system 20 supported on the chassis 16 and including a controller 22, a positioning system 24, and a navigation system 26, or any number or combination of devices, for controlling at least the speed and direction of travel of the autonomous vehicle 12. The controller 22 may also be in communication with various sensors and other devices in order to monitor and, thus, effectively control the autonomous operation of the autonomous vehicle 12.

The navigation system 26 may receive, access, and/or store a route plan, including a planned path 14, that is used to control operation of the autonomous vehicle 12. The navigation system 26 may be in communication with the positioning system 24, which may include one or more global positioning system (GPS) units receiving information from satellites to calculate machine position information, which may include at least a position and an orientation of the autonomous vehicle 12. The navigation system 26 may use the machine position information to establish a current location of the autonomous vehicle 12 and then determine how the autonomous vehicle 12 must be controlled, such as by controlling propulsion, steering, braking, and the like, to move the autonomous vehicle 12 along the planned path 14.

The autonomous vehicle 12 and/or, more particularly, the control system 20 may also include a detection system 28. The detection system 28 may communicate with or include obstacle detection devices or features, such as, for example, LIDAR, for detecting an event necessitating braking of the autonomous vehicle 12. Deviation from the planned path 14 and detection of an object 34 or other vehicle 36 within close proximity to the autonomous vehicle 12 may be considered events necessitating braking of the autonomous vehicle 12, for purposes of the present disclosure.

The controller 22 may receive the detection and/or the identification of the event, and determine or select a vehicle deceleration rate for the autonomous vehicle 12 based on the identification of the event. An operating mode, of a plurality of different predetermined operating modes, for the anti-lock braking system 52 may be selected, by the controller 22, based on the vehicle deceleration rate. For example, the controller 22 may be configured to operate the anti-lock braking system 52 in a “short stopping distance mode” if the vehicle deceleration rate is above a predetermined threshold. Alternatively, the controller 22 may be configured to operate the anti-lock braking system 52 in a “yaw control mode” if the vehicle deceleration rate is below a predetermined threshold.

The control strategy disclosed herein provides an effective means for optimizing control or, more specifically, braking of an autonomous vehicle. The control system and method disclosed herein detect an event necessitating braking of the autonomous vehicle and, in response, identify a deceleration rate based on the event, and automatically select an operating mode for the braking system or, more particularly, anti-lock braking system of the autonomous vehicle based on the deceleration rate. Such a strategy may not be possible on a manually driven vehicle, since a human operator is not likely to select a particular operating mode during an event necessitating braking, which may include an emergency stopping event.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. An anti-lock braking system for an autonomous vehicle, the anti-lock braking system including:
a memory storing instructions relating to braking control;
a detection system for detecting an event necessitating braking of the autonomous vehicle; and
a controller in communication with the detection system and configured to execute the instructions to:
receive detection and identification of the event;
determine a vehicle deceleration rate based on the identification of the event; and
operate the anti-lock braking system in a selected mode of a plurality of different predetermined operating modes based on the vehicle deceleration rate.

2. The anti-lock braking system of claim 1, wherein the controller is further configured to operate the anti-lock braking system in a short stopping distance mode if the vehicle deceleration rate is above a predetermined threshold.

3. The anti-lock braking system of claim 1, wherein the controller is further configured to operate the anti-lock braking system in a yaw control mode if the vehicle deceleration rate is below a predetermined threshold.

4. The anti-lock braking system of claim 1, further including at least one sensor positioned at each wheel of the anti-lock braking system to identify potential slippage at a particular wheel.

5. The anti-lock braking system of claim 4, wherein the controller is in communication with the at least one sensor positioned at each wheel and is further configured to operate the anti-lock braking system in the selected mode to control an axle supporting the particular wheel based on the potential slippage.

6. The anti-lock braking system of claim 1, wherein the detection system includes a light detection and ranging system for detecting objects within a predetermined proximity to the autonomous vehicle; and
wherein the controller is further configured to determine the deceleration rate based on information from the light detection and ranging system.

7. The anti-lock braking system of claim 1, wherein the detection system is further configured to detect a deviation of the autonomous vehicle from a planned path; and
wherein the controller is further configured to determine the deceleration rate based on the deviation.

8. The anti-lock braking system of claim 1, wherein the detection system is further configured to detect another vehicle within a predetermined proximity to the autonomous vehicle; and
wherein the controller is further configured to determine the deceleration rate based on the vehicle.

9. The anti-lock braking system of claim 1, wherein the detection system is further configured to detect a failure condition of a component or system of the autonomous vehicle; and
wherein the controller is further configured to determine the deceleration rate based on the vehicle.

10. The anti-lock braking system of claim 1, wherein the controller is further configured to determine the deceleration rate based on an identified stopping point and a current speed.

11. A method for identifying a selected mode for an anti-lock braking system of an autonomous vehicle, the method comprising:
detecting an event necessitating braking of the autonomous vehicle, the event being detected using a detection system;
receiving detection and identification of the event at a controller;
determining a vehicle deceleration rate based on the identification of the event using the controller; and
operating the anti-lock braking system in the selected mode of a plurality of different predetermined operating modes based on the vehicle deceleration rate.

12. The method of claim 11, wherein operating the anti-lock braking system includes operating the anti-lock braking system in a short stopping distance mode if the vehicle deceleration rate is above a predetermined threshold.

13. The method of claim 11, wherein operating the anti-lock braking system includes operating the anti-lock braking system in a yaw control mode if the vehicle deceleration rate is below a predetermined threshold.

14. The method of claim 11, wherein detecting the event includes detecting objects within a predetermined proximity of the autonomous vehicle using a light detection and ranging system.

15. The method of claim 11, wherein detecting the event includes detecting a deviation of the autonomous vehicle from a planned path.

16. A control system for an anti-lock braking system of an autonomous vehicle, including:
a memory storing instructions relating to braking control; and
a controller configured to execute the instructions to:
receive detection and identification of an event necessitating braking of the autonomous vehicle; and
determine a vehicle deceleration rate based on the identification of the event; and
operate the anti-lock braking system in a selected mode of a plurality of different predetermined operating modes based on the vehicle deceleration rate.

17. The control system of claim 16, wherein the controller is further configured to operate the anti-lock braking system in a short stopping distance mode if the vehicle deceleration rate is above a predetermined threshold.

18. The control system of claim 16, wherein the controller is further configured to operate the anti-lock braking system in a yaw control mode if the vehicle deceleration rate is below a predetermined threshold.

19. The control system of claim 16, wherein the controller is in communication with at least one sensor positioned at each wheel of the anti-lock braking system to identify potential slippage at a particular wheel, and the controller is further configured to operate the anti-lock braking system in the selected mode to control an axle supporting the particular wheel.

20. The control system of claim 16, wherein the controller is further configured to determine the deceleration rate based on an identified stopping point and a current speed.
